(19) United States
(12) Patent Application Publication
(10) Pub. No.: US 2014/0175120 A1
(43) Pub. Date: Jun. 26, 2014

(54) AUTOMATIC VENDING MACHINE

(71) Applicant: HON HAI PRECISION INDUSTRY CO., LTD, New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 13/970,962

(22) Filed: Aug. 20, 2013

(30) Foreign Application Priority Data
Dec. 26, 2012 (CN) 2012105738287

(51) Int. Cl. G07F 9/10

(52) U.S. Cl. CPC G07F 9/10
USPC 221/306

(57) ABSTRACT

An automatic vending machine able to store and dispense merchandise of different heights includes a cabinet and a door. The cabinet includes a cabinet body and defines a first latching hole and a second latching hole. The door includes door body and a hook located on the door body. The door is rotatable relative to the two side plates between a first position, where the hook is engaged in the first latching hole, and the door body is perpendicular to the two side plates to block a first taller product and a second position, where the hook is engaged in the second latching hole, and an acute angle is defined between the door body and each of the two side plates to block a second shorter product.

### BACKGROUND

1. Technical Field

The present disclosure relates to automatic vending machines, and more particularly to an automatic vending machine with a cabinet.

2. Description of Related Art

In an automatic vending machine, the vending machine includes a cabinet for stocking products and a door for keeping the products in the cabinet. On the one hand, the door is secured to the cabinet with screws, and assembly or disassembly of the door is very time-consuming and inconvenient. On the other hand, the door has a rigid position so as to block the first product in a line of products from disengaging from the cabinet, and it is very inconvenient to detach the door from the cabinet and change the position of the door to block a second product which has a smaller height than the first product height. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of an embodiment of an automatic vending machine.

FIG. 2 is an enlarged view of a circled portion II of FIG. 1.

FIG. 3 is an isometric view of a hanging piece of the automatic vending machine of FIG. 1.

FIG. 4 is an enlarged view of a circled portion IV of FIG. 1.

FIG. 5 is an assembled view of the automatic vending machine of FIG. 1, the door being located in a first position.

FIG. 6 is another assembled view of the automatic vending machine of FIG. 1, the door being located in a second position.

FIG. 7 is another assembled view of the automatic vending machine of FIG. 1, the door being located in a third position.

FIG. 8 is an enlarged view of a circled portion VIII of FIG. 7.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

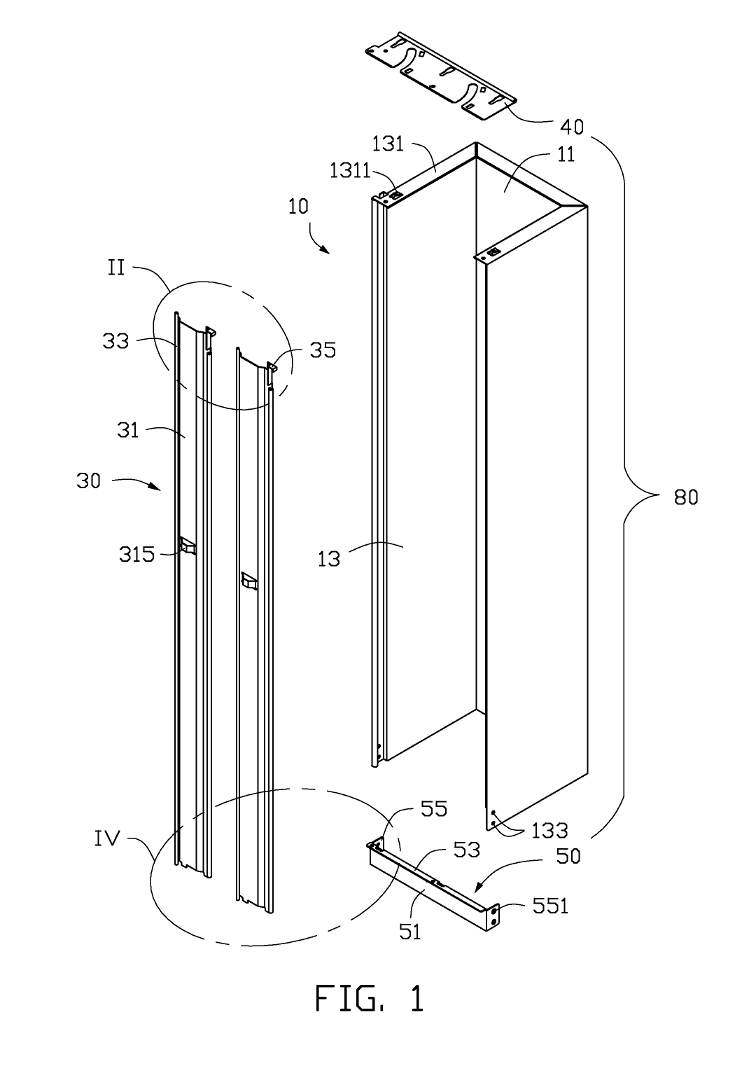

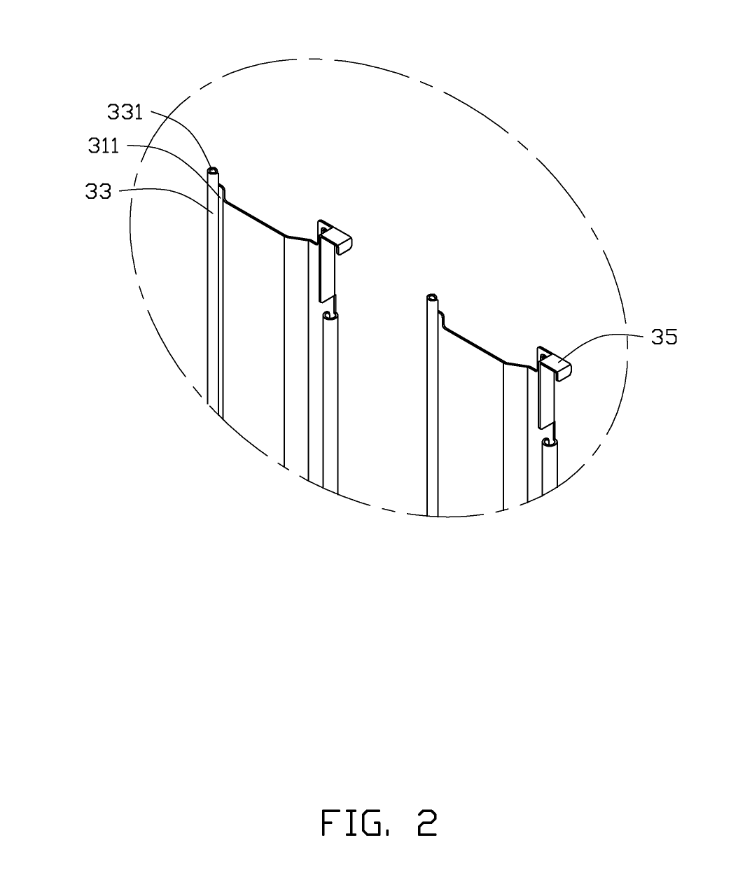

FIG. 1-4 illustrate an embodiment of an automatic vending machine which includes a cabinet 80 and two doors 30. The cabinet 80 holds products (not shown). The products may be, for example, canned drinks. The cabinet 80 includes a cabinet body 10, a hanging member 40, and a securing member 50.

The cabinet body 10 includes a bottom plate 11 and two side plates 13. The two side plates 13 are located on opposite edges of the bottom plate 11. In one embodiment, the two side plates 13 are parallel to each other and perpendicular to the bottom plate 11. A flange 131 perpendicularly extends from a top edge of each of the two side plates 13. A securing piece 1311 is located on the flange 131, for engaging with the hanging member 40. Each of the two side plates 13 defines two locking holes 133 at the bottom edge of each of the two side plates 13.

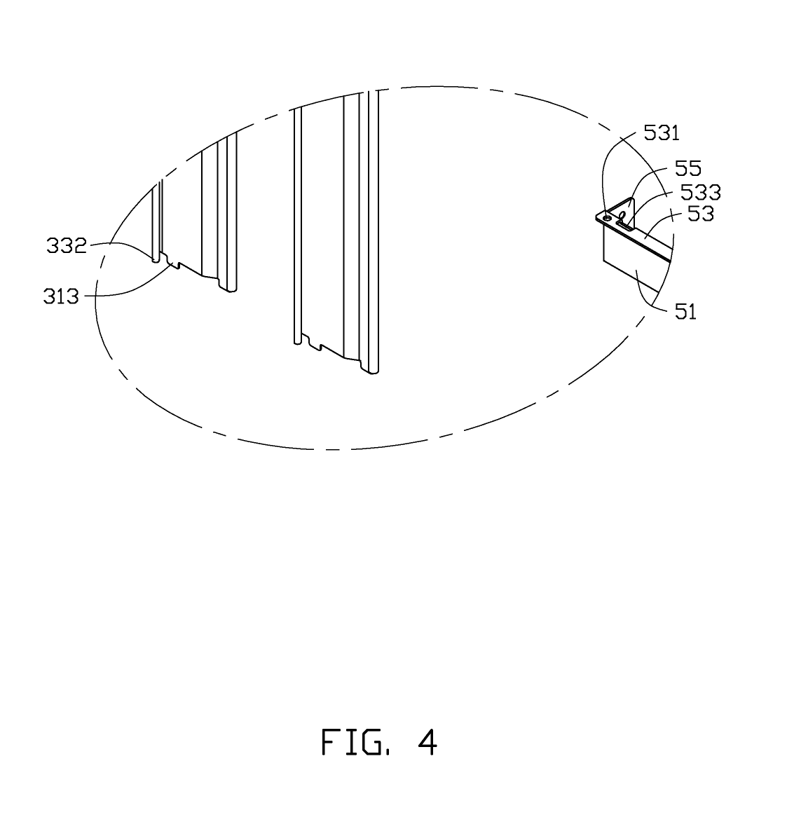

Each of the two doors 30 includes an elongated door body 31 and a rotating shaft 33 extending from one side of the door body 31. Length of the rotating shaft 33 is greater than the length of the door body 31. A hook 35 is located on the door body 31 and arranged at a right side of a top edge of the door body 31. A limiting tab 311 extends from the door body 31 and is connected to the rotating shaft 33, positioning on a left side of a top edge of the door body 31. A latching tab 313 (only shown in FIG. 4) extends from a bottom edge of the door body 31. An actuating piece 315 protrudes from the door body 31, located on a center of the door body 31. In one embodiment, the actuating piece 315 is substantially like a bridge.

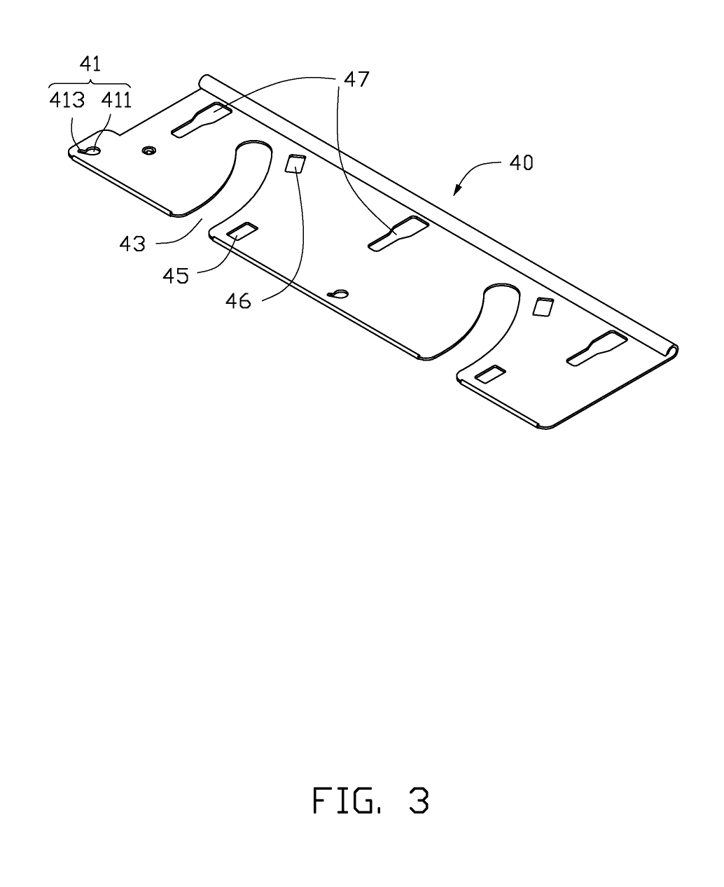

FIG. 3 shows that the hanging piece 40 defines a rotating hole 41, a guiding slot 43, and a first latching hole 45 and second latching hole 46 corresponding to each door 30. The guiding slot 43 is substantially arcuate and located in a circle with the rotating hole 41 as the center. The rotating hole 41 and the first and second latching holes 45, 46 are arranged at two opposite sides of the guiding slot 43. The rotating hole 41 includes a wide portion 411 and a narrow portion 413 in communication with the wide portion 411. An engaging hole 47 is defined in the hanging piece 40, corresponding to the securing piece 1311.

The securing member 50 includes a blocking piece 51 and two securing tabs 55. The two securing tabs 55 extend from opposite ends of the blocking piece 51 and define two securing holes 551 corresponding to the two locking holes 133. A supporting piece 53 perpendicularly extends from a top edge of the blocking piece 51 and defines a pivot hole 531 and a blocking hole 533 adjacent to the pivot hole 531. The pivot hole 531 is in line with the rotating hole 41.

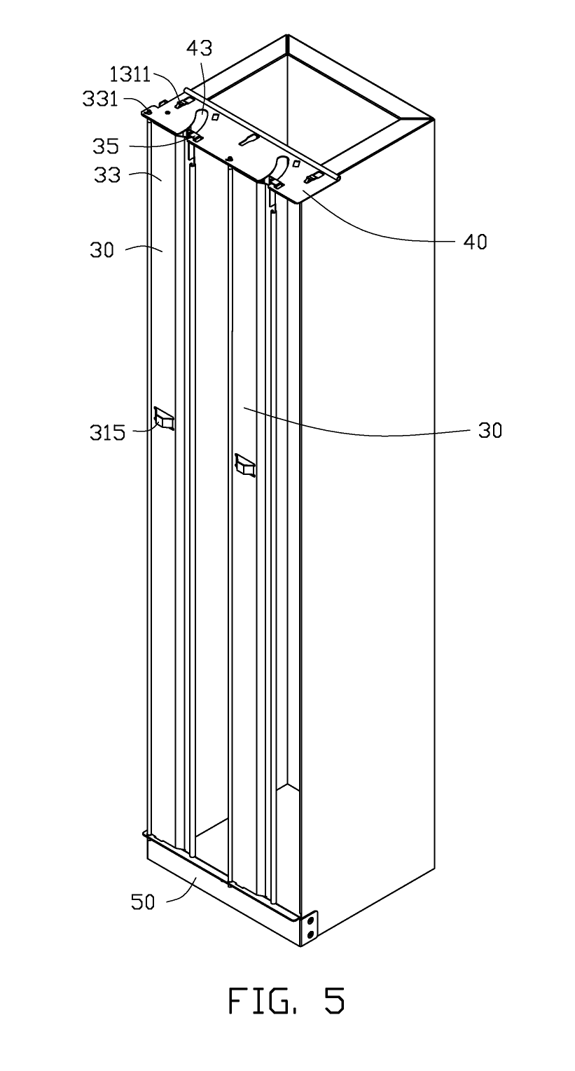

FIG. 5 shows that in assembly, a first end 331 of the rotating shaft 33 of the door 30 is inserted into the wide portion 411, and the limiting tab 311 is received in the narrow portion 413. A second end 332 opposite to the first end 331 of the rotating shaft 33 is aligned with the pivot hole 531. The door 30 is pulled down, until the second end 332 of the door 30 engages in the pivot hole 531, and the limiting tab 311 disengages from the narrow portion 413. The door 30 is thereby located in a first position, where the hook 35 is engaged in the first latching hole 45, the door body 31 is substantially perpendicular to each of the two side plates 13, and the latching tab 313 is engaged in the blocking hole 533. Thus, the door 30 blocks a first product (not shown).

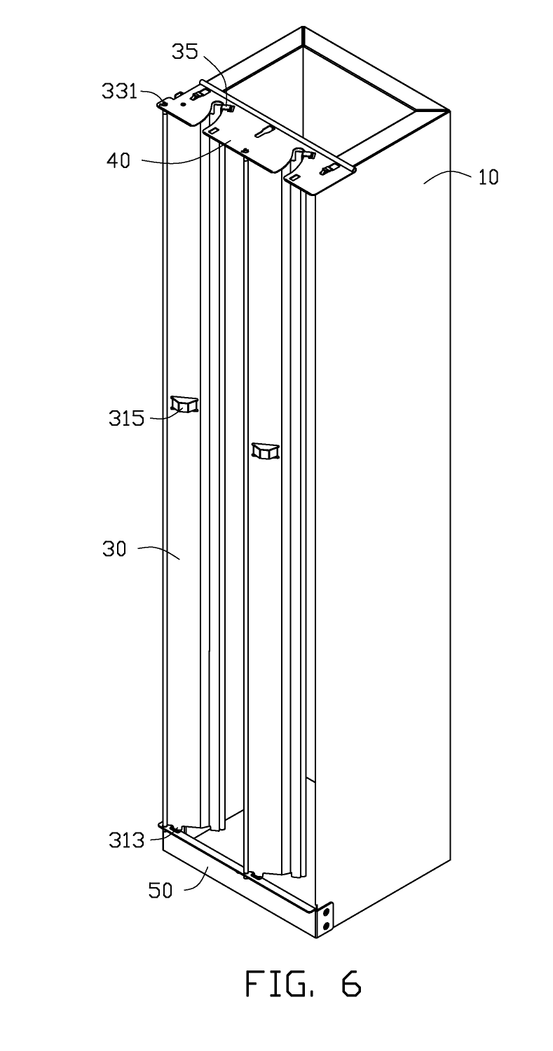

FIG. 6 shows that the door 30 is rotatable along a first direction. The hook 35 is rotatable in the guiding slot 43, until the hook 35 is engaged in the second latching hole 46, and an acute angle is defined between the door body 31 and each of the two side plates 13. The door 30 is then located in a second position to block a second product which is shorter than the first product. The latching tab 313 abuts the blocking piece 51.

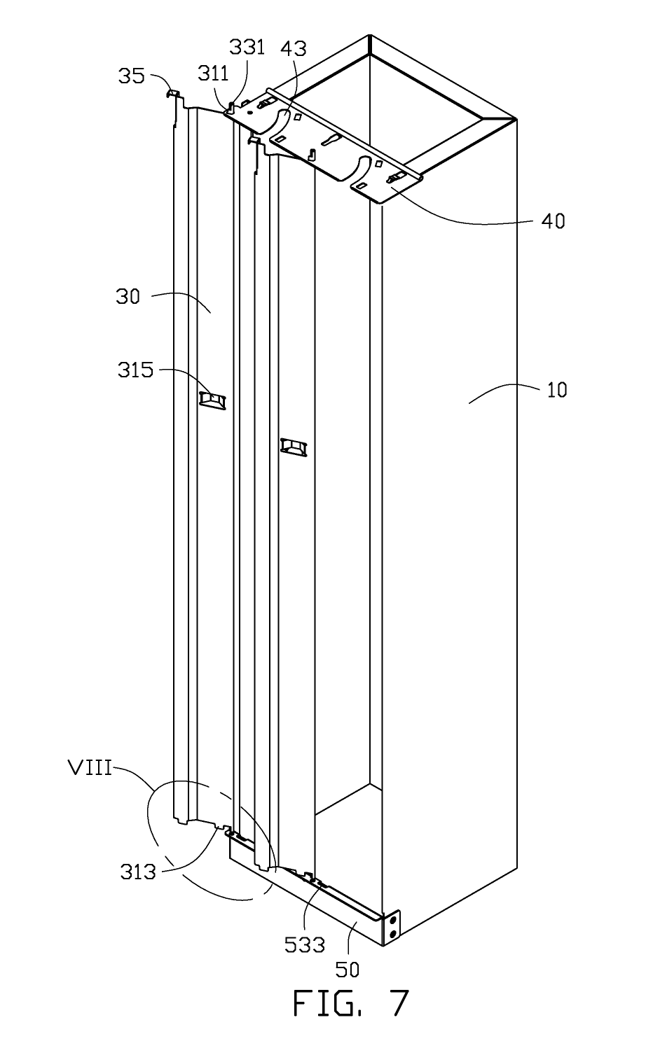

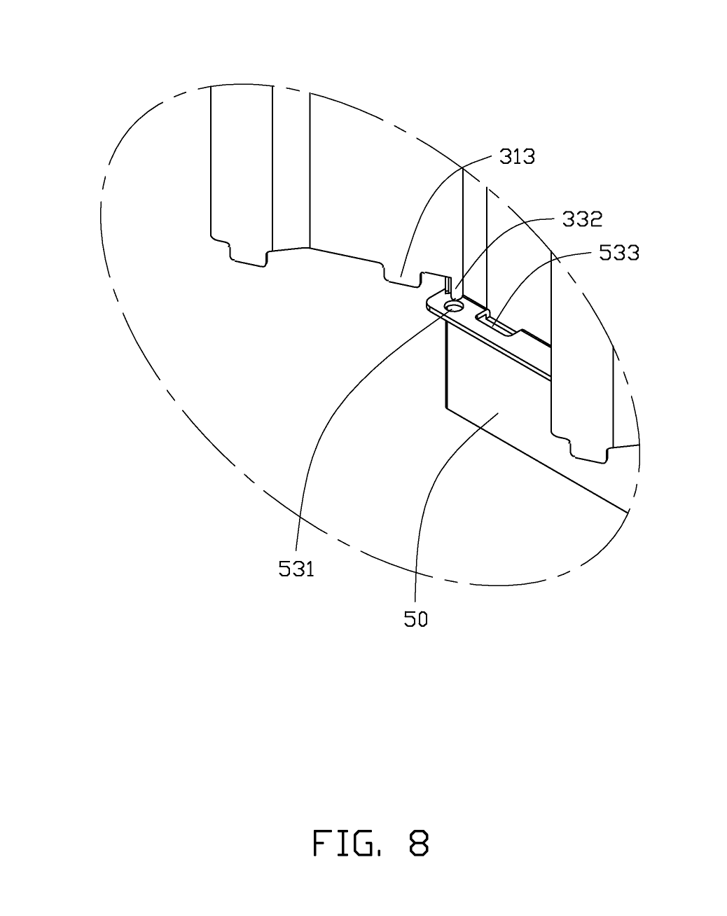

FIGS. 7 and 8 show that the door 30 is pulled up to disengage the latching tab 313 from the securing member 50. Simultaneously, the door 30 is rotated along a second direction opposite to the first direction, until the hook 35 disengages from the guiding slot 43, and an obtuse angle is defined between the door body 31 and each of the two side plates 13. Thus, the door 30 is located in a third position, and products can be added to the cabinets 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet comprising:
a cabinet body comprising two side plates, and the two side plates being parallel to each other;
a hanging piece secured to a first ends of the two side plates, and the hanging piece defines a first latching hole and a second latching hole; and
a securing member secured to a second ends opposite to the first ends of the two side plates; and
a door engaged between the hanging piece and the securing member and comprising a door body and a hook located on the door body,
wherein the door is rotatable relative to the two side plates between a first position and a second position; when the door is located in the first position, the hook is engaged in the first latching hole, and the door body is perpendicular to the two side plates; and
when the door is located in the second position, the hook is engaged in the second latching hole, and an acute angle is defined between the door body and each of the two side plates.

2. The automatic vending machine of claim 1, wherein the hanging piece further defines a guiding slot, and the hook is rotatable in the guiding slot.

3. The automatic vending machine of claim 2, wherein the guiding slot is substantially arcuate.

4. The automatic vending machine of claim 2, wherein the hanging piece defines a rotating hole, the securing member defines a pivot hole aligning with the rotating hole; the door further comprises a rotating shaft extending from one side of the door body; and a first end of the rotating shaft is engaged in the rotating hole, and a second end opposite to the first end of the rotating shaft is engaged in the rotating hole.

5. The automatic vending machine of claim 4, wherein the rotating hole and the first latching hole, the second latching hole are arranged at two opposite sides of the guiding slot, and the guiding slot is arranged in partial circle about a center of the rotating hole.

6. The automatic vending machine of claim 4, wherein the door further comprises a limiting tab extending from the door body and connected to the rotating shaft, and the limiting tab abuts the hanging piece, for preventing the door from moving relative to the hanging piece.

7. The automatic vending machine of claim 6, wherein the rotating hole comprises a wide portion and a narrow portion in communication with the wide portion, and the second end of the rotating shaft is adapted to disengage from the pivot hole with the limiting tab being received in the narrow portion and the first end being received in the wide portion.

8. The automatic vending machine of claim 1, wherein the securing member defines a blocking hole, the door further comprises a latching tab extending from door body opposite to the hook; when the door is located in the first position, the latching tab is engaged in the blocking hole; and when the door is located in the second position, the latching tab is disengaged from the blocking hole.

9. The automatic vending machine of claim 1, wherein the door is further rotatable relative to the two side plates between the first position and a third position; and when the door is located in the third position, the hook is disengage from the first latching hole and the second latching hole, and an obtuse angle is defined between the door body and each of the two side plates.

10. An automatic vending machine comprising:
a cabinet comprising two parallel side plates and defining a first latching hole and a second latching hole; and
a door secured to the cabinet and comprising a door body and a hook located on the door body,
wherein the door is rotatable relative to the two side plates between a first position and a second position; when the door is located in the first position, the hook is engaged in the first latching hole, and the door body is perpendicular to the two side plates; when the door is located in the second position, the hook is engaged in the second latching hole, and an acute angle is defined between the door body and each of the two side plates.

11. The automatic vending machine of claim 10, wherein the cabinet further comprises a hanging piece and the hanging piece is secured to a first ends of the two side plates and substantially perpendicular to the two side plates.

12. The automatic vending machine of claim 11, wherein the hanging piece further defines a guiding slot, and the hook is rotatable in the guiding slot.

13. The automatic vending machine of claim 12, wherein the guiding slot is substantially arcuate.

14. The automatic vending machine of claim 12, wherein the hanging piece defines a rotating hole, and the cabinet further comprises a securing member secured to a second ends of the two side plates; the securing member defines a pivot hole aligning with the rotating hole; the door further comprises a rotating shaft extending from one side of the door body; and a first end of the rotating shaft is engaged in the rotating hole, and a second end opposite to the first end of the rotating shaft engages the rotating hole.

15. The automatic vending machine of claim 14, wherein the first latching hole and the second latching hole are defined in the hanging piece, the rotating hole and the first latching hole; two second latching holes are arranged with one hole at each of two opposite sides of the guiding slot, and the guiding slot is arranged in a circle with the rotating hole as the center.

16. The automatic vending machine of claim 14, wherein the door further comprises a limiting tab extending from the door body and connected to the rotating shaft, and the limiting tab abuts the hanging piece, for preventing the door from moving relative to the hanging piece.

17. The automatic vending machine of claim 16, wherein the rotating hole comprises a wide portion and a narrow portion in communication with the wide portion, and the second end of the rotating shaft is adapted to disengage from the pivot hole with the limiting tab being received in the narrow portion and the first end being received in the wide portion.

18. The automatic vending machine of claim 14, wherein the securing member defines a blocking hole, and the door further comprises a latching tab extending from door body opposite to the hook; when the door is located in the first position, the latching tab is engaged in the blocking hole; and when the door is located in the second position, the latching tab is disengaged from the blocking hole.

19. The automatic vending machine of claim 18, wherein the door is rotatable relative to the two side plates between the first position and a third position; and when the door is located in the third position, the hook is disengage from the first latching hole and the second latching hole, and an obtuse angle is defined between the door body and each of the two side plates.
